(19) United States
(12) Patent Application Publication
(10) Pub. No.: US 2025/0385981 A1
(43) Pub. Date: Dec. 18, 2025

(54) IMAGE PROCESSING APPARATUS, METHOD, AND STORAGE MEDIUM STORING PROGRAM

(71) Applicant: CANON KABUSHIKI KAISHA, Tokyo (JP)

(72) Inventors: HIROAKI OGAWA, Kanagawa (JP); MASAAKI OBAYASHI, Kanagawa (JP); SHINICHI MIYAZAKI, Kanagawa (JP); FUMINO MATSUI, Kanagawa (JP); AKITOSHI YAMADA, Kanagawa (JP); HISASHI ISHIKAWA, Chiba (JP)

(21) Appl. No.: 19/236,886

(22) Filed: Jun. 12, 2025

(30) Foreign Application Priority Data
Jun. 14, 2024 (JP) 2024-096897

(51) Int. Cl. H04N 1/60

(52) U.S. Cl. CPC H04N 1/6066; H04N 1/6027; H04N 1/603

(57) ABSTRACT

An image processing apparatus includes: an input unit that inputs image data, and a color conversion unit that, on the image data input by the input unit, executes color conversion using a first color conversion method on a target pixel with a difference in pixel value between the target pixel and a surrounding pixel in a case where the target pixel satisfies a condition and execute color conversion using a second color conversion method different from the first color conversion method on the target pixel in a case where the target pixel does not satisfy the condition. A result of executing color conversion using the first color conversion method maintains tonality more than a result of color conversion using the second color conversion method.

### BACKGROUND

### Field of the Technology

The present disclosure relates to an image processing apparatus that can execute mapping, a method for the image processing apparatus, and a storage medium storing a program.

### Description of the Related Art

A known printer, on the basis of digital document data described in a predetermine color space, performs mapping for each color in the color space to a color reproduction region that can be reproduced by a printer and outputs an image. In a known example, an object in a document is identified, colorimetric mapping is performed for a graphic region, and perceptual mapping is performed for a photo region.

In a case where colorimetric mapping is performed, color degeneration may occur in the plurality of colors included in the digital document. Japanese Patent Laid-Open No. 2024-008265 describes increasing the distance between colors of colors susceptible to color degeneration so that color mapping to a color gamut that can be reproduced by a printer is performed to reduce the degree of color degeneration.

### SUMMARY

The present disclosure provides an image processing apparatus that can obtain an appropriate color conversion result regardless of the region in the image, a method, and a storage medium storing a program.

The present disclosure in one aspect provides an image processing apparatus comprising: at least one memory and at least one processor which function as: an input unit configured to input image data, and a color conversion unit configured to, on the image data input by the input unit, execute color conversion using a first color conversion method on a target pixel with a difference in pixel value between the target pixel and a surrounding pixel in a case where the target pixel satisfies a condition and execute color conversion using a second color conversion method different from the first color conversion method on the target pixel in a case where the target pixel does not satisfy the condition, wherein a result of executing color conversion using the first color conversion method maintains tonality more than a result of color conversion using the second color conversion method.

According to the present disclosure, an appropriate color conversion result can be obtained regardless of the region in the image.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating the configuration of an image processing apparatus.

FIG. 2 is a diagram for describing a print head.

FIG. 3 is a flowchart illustrating processing in the image processing apparatus.

FIG. 4 is a flowchart illustrating processing in the image processing apparatus.

FIG. 5 is a flowchart illustrating processing of step S202.

FIG. 6 is a diagram for describing color degeneration and its correction.

FIGS. 7A and 7B are diagrams for describing first region setting processing.

FIG. 8 is a flowchart illustrating processing in the image processing apparatus.

FIG. 9 is a flowchart illustrating processing in the image processing apparatus.

FIG. 10 is a diagram for describing determination processing of step S104.

FIGS. 11A to 11D are diagrams for describing a color conversion method.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

By applying a color conversion method in accordance with the region in an image, if the region includes a region that need the tonality maintained, an appropriate color conversion result may not be obtained.

According to the present disclosure, an appropriate color conversion result can be obtained regardless of the region in the image.

### First Embodiment

The terminology used in the present specification will be defined in advance as follows.

### Color Reproduction Region

“Color reproduction region” may also be referred to as color reproduction range, color gamut, and gamut. Typically, “color reproduction region” refers to a range of colors that is reproducible in a discretionary color space. Also, color gamut volume is used as an index representing the size of the color reproduction region. The color gamut volume is a three-dimensional volume in a discretionary color space. Chromaticity points forming the color reproduction region may be discrete. For example, a specific color reproduction region is represented by 729 points on CIE-L*a*b*, and points between them are obtained by using a known interpolation operation such as tetrahedral interpolation or cubic interpolation. In this case, as the corresponding color gamut volume, it is possible to use a volume obtained by calculating the volumes on CIE-L*a*b* of tetrahedrons or cubes forming the color reproduction region and accumulating the calculated volumes, in accordance with the interpolation operation method. The color reproduction region and the color gamut in the present embodiment are not limited to a specific color space, but in the present embodiment, an example is described in which a color reproduction region in the CIE-L*a*b* space is used. Also, the numerical value of the color reproduction region in the present embodiment indicates the volume obtained by accumulation in the CIE-L*a*b* space based on tetrahedral interpolation.

### Gamut Mapping

Gamut mapping is processing of converting different color gamut spaces and is, for example, mapping of an input color gamut to an output color gamut of a device such as a printer. Perceptual, saturation, colorimetric, and the like of the ICC profile are typical examples. Mapping processing may be implemented via conversion using a three-dimensional look-up table (3D LUT), for example. Also, the mapping processing may be executed after color space conversion into a standard color space. For example, in a case where the input color space is sRGB, the input color space is converted into the CIE-L*a*b* color space, and then processing to map this on an output color gamut in the CIE-L*a*b* color space is executed. Mapping processing may be conversion via a 3D LUT or may using a conversion formula. Also, conversion of the color space at the time of input and the color space at the time of output may be performed simultaneously. For example, at the time of input it may be an sRGB color space, and at the time of output it may be converted to an RGB value or a CMYK value unique to the printer.

### Document Data

Document data refers to the entire input digital data to be processed. The document data includes from one to a plurality of pages. Each single page may be held as image data or may be represented as a drawing command. In a case where the data is represented as a drawing command, the data may be rendered, converted into image data, and then processed. The image data may be formed by a plurality of pixels two-dimensionally arranged. Each pixel holds information indicating a color in the color space. Examples of the information indicating a color are, for example, RGB values, CMYK values, a K value, CIE-L*a*b* values, HSV values, HLS values, and the like. Note that the present embodiment can be applied in the case of one page and in the case of a plurality of pages. The present embodiment will be described using one page of document data as the image data as an example.

### Color Degeneration

In the present embodiment, color degeneration is defined as the distance between colors after mapping in a predetermined color space being less than the distance between colors before mapping when gamut mapping is performed of two discretionary colors. Specifically, in the digital document, there is a color A and a color B, and by performing mapping in the color gamut of the printer, the color A is converted to a color C and the color B is converted to a color D. In this case, color degeneration is defined as the distance between the color C and the color D being less than the distance between the color A and the color B. When there is color degeneration, colors that are recognized as being different in the digital document are recognized as the same color when printed. For example, in a graph, different items are recognized by making different items different colors. When there is color degeneration, there is a possibility of different colors being recognized as the same color and different items in the graph being falsely recognized as the same item. The predetermined color space for calculating the distance between colors here may be a discretionary color space. For example, sRGB color space, Adobe RGB color space, CIE-L*a*b* color space, CIE-LUV color space, XYZ color system color space, xyY color system color space, HSV color space, HLS color space, or the like may be used.

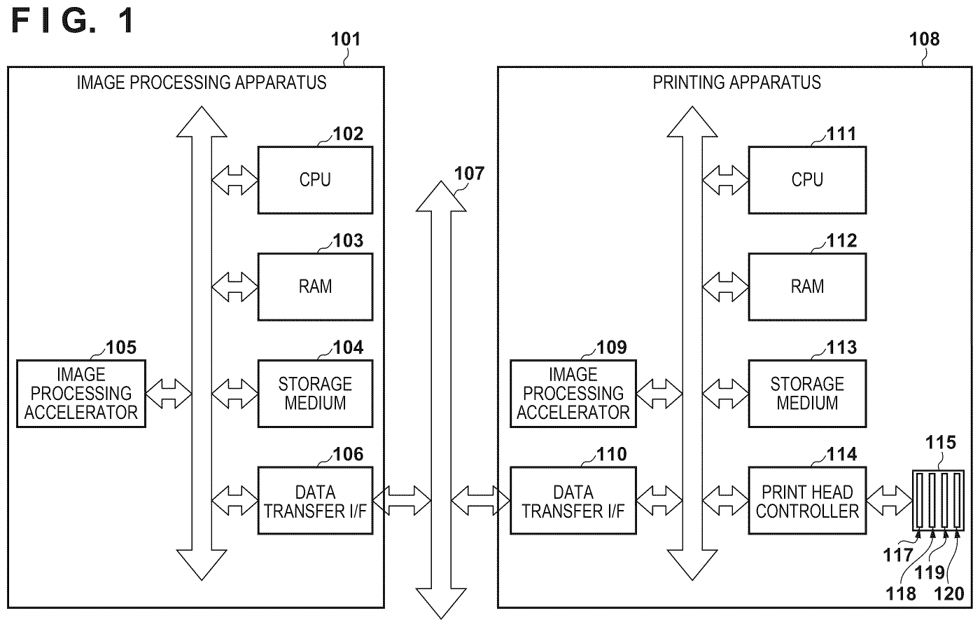

FIG. 1 is a block diagram illustrating an example of the configuration of an image processing apparatus according to the present embodiment. A PC, a tablet, a server, or a printing apparatus may be used as an image processing apparatus 101, for example. FIG. 1 illustrates an example in which the image processing apparatus 101 is configured separate to a printing apparatus 108. A CPU 102 executes various types of image processing by reading out a program stored in a storage medium 104, such as a HDD or a ROM, onto a RAM 103 serving as a working area and executing the program. For example, the CPU 102 obtains a command from a user via a human interface device (HID) I/F (not illustrated). Then, the various types of image processing are executed according to the obtained command and the program stored in the storage medium 104. Also, the CPU 102 executes predetermined processing according to a program stored in the storage medium 104 on document data obtained via a data transfer I/F 106. Then, the CPU 102 displays this result and/or various information on a display (not illustrated) and transmits it as print data via the data transfer I/F 106.

An image processing accelerator 105 is a piece of hardware that can execute image processing at higher speeds than the CPU 102. The image processing accelerator 105 is activated by the CPU 102 writing the parameters and data required for image processing to a predetermined address of the RAM 103. The image processing accelerator 105 executes image processing on the data after the parameters and data described above are loaded. However, the image processing accelerator 105 is not a required component, and similar processing may be executed by the CPU 102. Specifically, an image processing accelerator is a GPU or an exclusively designed electric circuit. The parameters described above may be stored in the storage medium 104 or may be obtained from the outside via the data transfer I/F 106. The image processing apparatus 101 is not limited to the configuration illustrated in FIG. 1 and may have a configuration appropriate for the functions executable by the device used as the image processing apparatus 101.

In the printing apparatus 108, a CPU 111 comprehensively controls the printing apparatus 108 by reading out a program stored in a storage medium 113 onto a RAM 112 serving as the working area and executes the program. An image processing accelerator 109 is a piece of hardware that can execute image processing at higher speeds than the CPU 111. The image processing accelerator 109 is activated by the CPU 111 writing the parameters and data required for image processing to a predetermined address of the RAM 112. The image processing accelerator 109 executes image processing on the data after the parameters and data described above are loaded. However, the image processing accelerator 109 is not a required component, and similar processing may be executed by the CPU 111. The parameters described above may be stored in the storage medium 113 or may be stored in a storage (not illustrated) such as a flash memory, HDD, or the like.

Here, the image processing executed by the CPU 111 or the image processing accelerator 109 will be described. The image processing is processing to generate data indicating dot formation positions of the ink for each scan by a print head 115 on the basis of the obtained print data. The CPU 111 or the image processing accelerator 109 executes color conversion processing on the obtained print data and quantization processing.

Color conversion processing is processing to separate colors by the ink density handled by the printing apparatus 108. For example, the obtained print data includes image data indicating an image. In a case where the image data is data indicating an image in a color space coordinate system such as sRGB as the expression colors of a monitor, data indicating an image by color coordinates (R, G, B) of the sRGB is converted into ink data (CMYK) to be handled by the printing apparatus 108. The color conversion method is implemented by matrix operation processing or processing using a 3D LUT or a 4D LUT.

The printing apparatus 108 according to the present embodiment uses black (K), cyan (C), magenta (M), and yellow (Y) in printing, for example. Thus, image data of an RGB signal is converted into image data including 8-bit color signals for K, C, M, and Y. The color signal of each color corresponds to the applied amount of ink of each color. Also, the number of ink colors in this example is four: K, C, M, and Y. However, to improve image quality, low-density colors such as fluorescent ink (F), light cyan (Lc), light magenta (Lm), and gray (Gy) and other similar ink colors may be used. In this case, color signals corresponding to these inks are generated.

After the color conversion processing, quantization processing is executed on the ink data. The quantization processing is processing to reduce the level numbers of tones in the ink data. In the present embodiment, quantization is performed using a dither matrix including an array of thresholds for comparing ink data values for each pixel. Via quantization, ultimately, binary data indicating whether or not to form a dot at each dot formation position is generated.

After the image processing, the binary data is transferred to the print head 115 by a print head controller 114. The CPU 111 performs print control to run the carriage motor (not illustrated) for operating the print head 115 via the print head controller 114 and to run the conveyance motor for conveying the printing medium simultaneously. The print head 115 scans on the printing medium, and simultaneously, ink droplets are discharged on the printing medium by the print head 115 to form an image.

The image processing apparatus 101 and the printing apparatus 108 are connected via a communication line 107. In the present embodiment, a local area network (LAN) is used as an example of the communication line 107. However, a USB hub, a wireless communication network using a wireless access point, a connection using a WiFi Direct communication function, or the like may be used. Also, apparatuses other than the image processing apparatus 101 and the printing apparatus 108 may be connected to the communication line 107. For example, a host PC may be connected to the communication line 107, and both the image processing apparatus 101 and the printing apparatus 108 may be communicably connected to the host PC in a communication-enabling manner.

In the following examples, the print head 115 includes a nozzle array for four colors of ink: cyan (C), magenta (M), yellow (Y), and black (K).

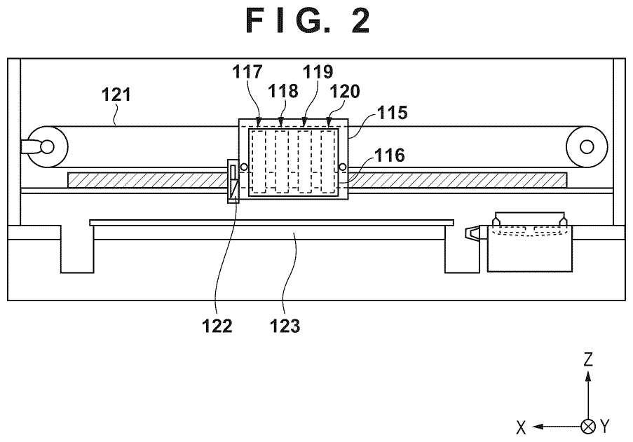

FIG. 2 is a diagram for describing the print head 115 according to the present embodiment. In the present embodiment, an image is printed by performing N number of scans for a unit region corresponding to one nozzle array. The print head 115 includes a carriage 116; nozzle arrays 117 (K), 118 (C), 119 (M), and 120 (Y); and an optical sensor 122. The carriage 116 is installed with the five nozzle arrays 117, 118, 119, and 120 and the optical sensor 122 and can move back and forth in the X direction in the diagram (main scan direction) via the driving force of a carriage motor transferred via a belt 121. The carriage 116 moves in the X direction relative to the printing medium as ink droplets are discharged in the gravity direction (Z direction in the diagram) from each nozzle of the nozzle arrays on the basis of the image data. Accordingly, an image corresponding to 1/N of the main scan is printed on the printing medium placed on a platen 123. When one main scan is complete, the printing medium is conveyed a distance corresponding to the width of 1/N of the main scan in the conveyance direction (−Y direction in the diagram) intersecting the main scan direction. With these operations, an image with a width corresponding to one nozzle array is printed via a plurality of scans corresponding to N times. By alternately repeating the main scan and the conveyance operation, an image is gradually formed on the printing medium. In this manner, control is performed to complete the image printing in the predetermined region.

In the present embodiment, consider an example in which a gradation region (tone region) such as a bar graph with a graphic region represented by tones is included, and the region other than the gradation region in the graphic region is a solid region. In the case of applying a color conversion method on the basis of the result of region detection, the color conversion method applied to the detected graphic region is also applied to the gradation region. The greater the proportion of the solid region is to the gradation region, the more this possibility increases. As a result, the tonality is disrupted, and unnatural tone gradients and color transitions appear. Regarding this, with the present embodiment, an appropriate color conversion method can be applied even in such cases by determining the color conversion method on a pixel basis.

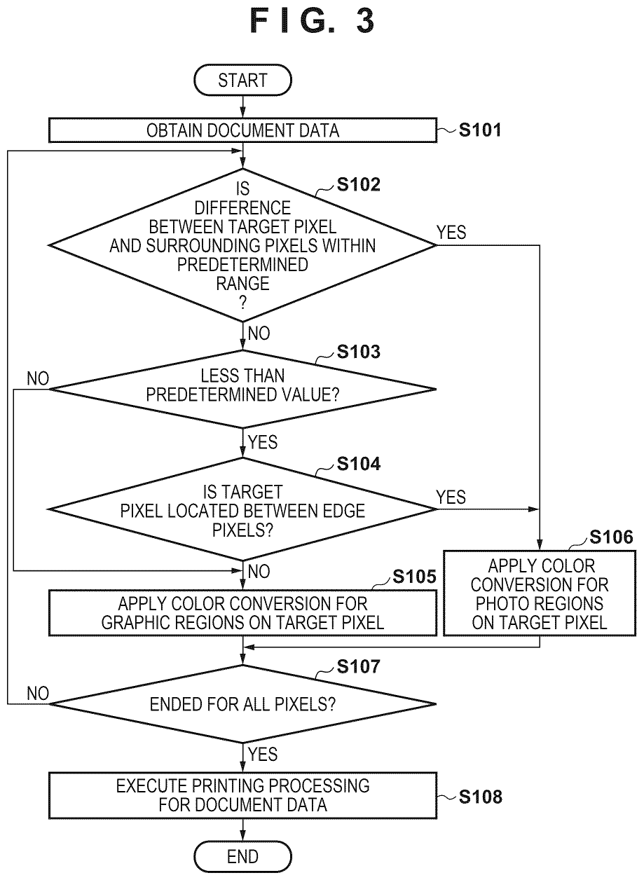

FIG. 3 is a flowchart illustrating processing in an image processing apparatus 101. The processing in FIG. 3 is implemented by a CPU 102 reading out a program stored on a RAM 103 and executing the program, for example. In the present embodiment, a configuration is described in which the processing of FIG. 3 is executed by the image processing apparatus 101. However, in another configuration, the processing may be executed by a printing apparatus 108 or the processing may be shared between the image processing apparatus 101 and the printing apparatus 108.

In step S101, the CPU 102 obtains document data corresponding to the print target for the printing apparatus 108. Specifically, for example, the CPU 102 receives document data from an external host PC via a data transfer I/F 106 of the image processing apparatus 101. Note that document data refers to image data in which a plurality of pixels are two-dimensionally arranged. Also, document data refers to RGB data defined in an RGB color space.

In step S102, the CPU 102 targets a pixel in the image indicated by the image data. Then, the CPU 102 determines, for the target pixel, whether or not a difference in the pixel value with the surrounding pixels is within a predetermined range. Note that the target pixel may be selected for analysis one at a time, or the resolution may be reduced to collectively analyze a plurality of pixels, such as four or sixteen, as one target. In the case of a plurality of pixels, analysis pixel value may be the average pixel value of a plurality of pixels or may be the pixel value of a specific pixel from among the plurality of pixels. By reducing the resolution in this manner, the number of pixels to compute can be reduced, and the processing can be sped up. Also, by using the average, the effects of noise can be reduced. Also, by converting the resolution by downsampling pixels, the processing can be simplified at the same time as avoiding the effects of blurring caused by interpolation.

A difference ΔRGB(x, y) in pixel value between the target pixel and the surrounding pixels adjacent to the target pixel is calculated via Formulas (1) to (4), where the RGB values of coordinates (x, y) represented as R(x, y), G(x, y), and B(x, y).

$$Δ R ( x , y ) = MAX ( ABS ( R ( x - 1 , y ) - R ( x , y ) ) , ABS ( R ( x , y - 1 ) - R ( x , y ) ) ) \qquad ( 1 )$$

$$Δ G ( x , y ) = MAX ( ABS ( G ( x - 1 , y ) - G ( x , y ) ) , ABS ( G ( x , y - 1 ) - G ( x , y ) ) ) \qquad ( 2 )$$

$$Δ B ( x , y ) = MAX ( ABS ( B ( x - 1 , y ) - B ( x , y ) ) , ABS ( B ( x , y - 1 ) - B ( x , y ) ) ) \qquad ( 3 )$$

$$Δ RGB ( x , y ) = MAX ( Δ R ( x , y ) , Δ G ( x , y ) , Δ B ( x , y ) ) \qquad ( 4 )$$

Here, MAX(a, b, c) is a function for calculating the maximum value of a, b, c; and ABS(d) is a function for calculating the absolute value of d.

The predetermined range used as an example in the present embodiment is a range from 3 to 15. Here, “3” is an example of a difference value representing noise level, and “15” is an example of a difference value representing edge level. In other words, in a case where the difference in pixel value between the target pixel and the surrounding pixel is greater than 15, it is determined to be an edge pixel. Here, an edge pixel is, for example, a pixel at the edge portion (edge portion) of a gradation region. In this case, in step S101, it is assumed that the difference is determined to not be within the predetermined range, and the processing proceeds to step S103.

Also, in a case where the difference in pixel value between the target pixel and the surrounding pixel is within a range from 3 to 15, the target pixel can be determined to be a pixel of a photo region. In this case, in step S101, it is assumed that the difference is determined to be within the predetermined range, and the processing proceeds to step S106.

In step S106, the CPU 102 determines that the target pixel is a target for photo region color conversion and performs color conversion on the target pixel via a color conversion method for photo regions prepared in advance. Step S107 follows step S106.

Also, in a case where the difference in pixel value between the target pixel and the surrounding pixel is less than 3, in other words, ΔRGB(x, y) is very small, in step S101, the difference is determined to not be in the predetermined range, and the processing proceeds to step S103. For a solid region of a graphic region, the difference in pixel value between the target pixel and the surrounding pixel is ideally 0. However, as a result of noise being included, ΔRGB(x, y) may be calculated as a very small value. Thus, in the present embodiment, the determination of whether a target pixel with such a calculated value is a photo region or a graphic region is temporarily put on hold at the timing of step S102, and the predetermined range corresponding to the determination criteria in step S102 is a range from the noise level to the edge level.

In step S103, the CPU 102 determines whether or not the difference in pixel value is less than a predetermined value. The predetermined value here is a difference value of 15 representing the edge level. In a case where it is determined that the difference is less than the predetermined value, the pixel is determined to be an edge pixel, and the processing proceeds to step S105. For example, if the difference in pixel value is 16, the processing proceeds from step S102 to step S103 to step S105.

In step S105, the CPU 102 determines that the target pixel is a target for graphic region color conversion and performs color conversion on the target pixel via a color conversion method for graphic regions prepared in advance. Step S107 follows step S105. In other words, a color conversion method for graphic regions is applied to the edge pixel.

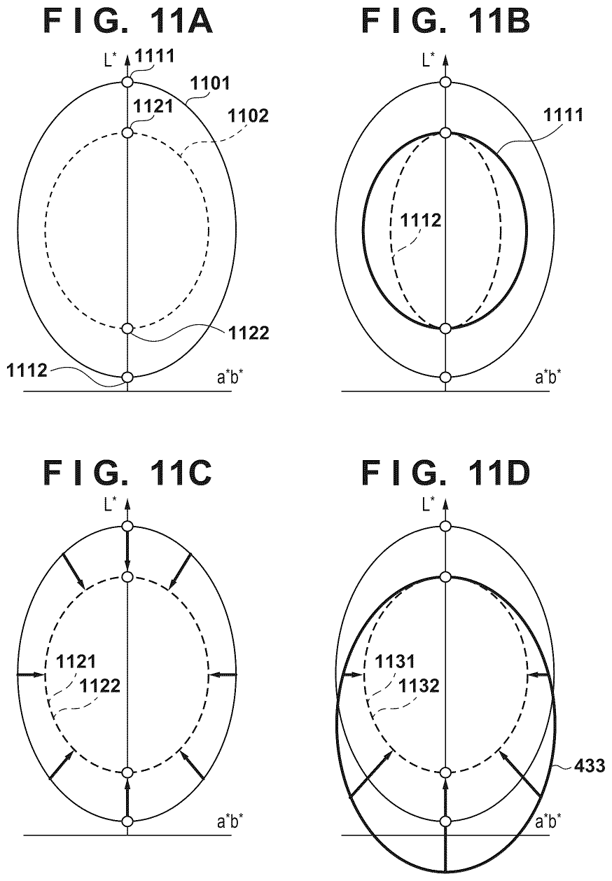

FIGS. 11A to 11D are diagrams for describing the color conversion method set in steps S105 and S106. FIG. 11A is a diagram illustrating the relationship between the color space of a standard display and the color space of the printing apparatus 108. In other words, a solid line 1101 in FIG. 11A is, in an L*a*b* uniform color space, an sRGB color space as defined is IEC 61966-2-1:1999 and an available color space for the document data from the host PC. A dashed line 1102 in FIG. 11A is a color reproduction color gamut of the printing apparatus 108.

When the colors displayed by a standard display are output by a printing apparatus, colors that are outside of the color reproduction region of the printing apparatus need to be associated with a suitable color in the color reproduction region. This is typically referred to as color space compression (color mapping). In general, there are a plurality of color space compression methods, and these are selectively used according to the purpose. In FIG. 11A, WP 1111 and WP 1121 are the brightest colors (white points) in the reproduction range of the standard display and the printing apparatus 108, respectively. BP 1112 and BP 1122 are the darkest colors (black points) in the reproduction range of the standard display and the printing apparatus 108, respectively.

FIG. 11B is a diagram for describing the color conversion method applied in step S106. As indicated by the bold solid line portion 1111 in FIG. 11B, the white point and the black point of the standard display are mapped to the white point and the black point of the color reproduction color gamut of the printing apparatus 108, respectively. Also, other colors are converts so that the correlation between the white point and the black point is maintained. Conversion is performed by compressing the chroma in the color direction so that the entire color space 1101 of the standard display fits within a color reproduction color gamut 1102 of the printing apparatus 108. Accordingly, the colors in the color space 1101 of the standard display are converted to the bold line 1111, and the colors in the original color reproduction color gamut 1102 are converted to the bold dashed line 1112. The color conversion method of FIG. 11B is suited to processing of data of images such as photos with a large range of colors. In FIG. 11B, just about all of the color gamut range of the standard display is compressed in terms of brightness and chroma.

FIG. 11C is a diagram for describing the color conversion method applied in step S105. This method, as illustrated in FIG. 11C, does not compress the colors in the color reproduction color gamut of the printing apparatus 108 and compresses the colors outside of the color reproduction color gamut in terms of brightness and chroma. The bold arrows in FIG. 11C represent the compression processing. The plurality of colors included in the bold arrow would be represented as different colors on the standard display, but become the same color as the arrow end point after mapping.

In step S105, the color conversion method illustrated in FIG. 11D may be applied. As illustrated in FIG. 11D, in this method, after only the white point of the standard display is mapped to the white point of the printing apparatus 108, the colors in the color reproduction color gamut of the printing apparatus 108 are not compressed and the colors outside of the print color gamut are compressed in terms of brightness and chroma. This is for the purpose of reproducing the relative color difference between white and each color in the standard display as a relative color difference between white and each color upon printing, and this is referred to as “relative colorimetric”. In this color conversion method also, the plurality of colors included in the bold arrow would be represented as different colors on the standard display, but become the same color as the arrow end point after color conversion.

In step S105, another color conversion method may be used in which, after mapping of the white point and the black point of the standard display to the white point and the black point of the printing apparatus 108, the colors in the color reproduction color gamut of the printing apparatus 108 are not compressed and the colors outside of the color reproduction color gamut are compressed in terms of chroma.

In a case where it is determined in step S103 that the difference is less than the predetermined value, the processing proceeds to step S104. For example, if the difference in pixel value is 2, the processing proceeds from step S102 to step S103 to step S104.

In step S104, the CPU 102 determines whether or not the target pixel is located between edge pixels. In the present embodiment, in a case where it is determined that the difference in pixel value is a very small value outside of the predetermined range in step S102, whether to apply to the target pixel the color conversion method for graphic regions or the color conversion method for photo regions is determined via the determination processing of step S104.

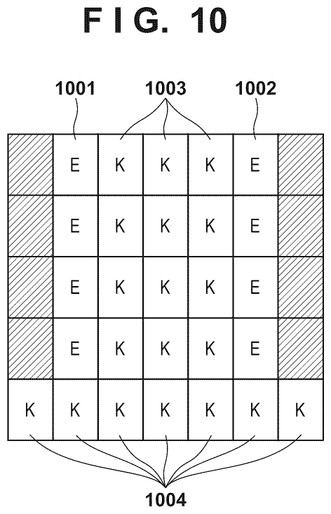

FIG. 10 is a diagram for describing the determination processing of step S104. A pixel 1001 and a pixel 1002 of FIG. 10 are edge pixels (indicated by “E”) determined to have a difference with an adjacent surrounding pixel that is greater than the edge level. Here, for the sake of description, the difference in pixel value with an adjacent surrounding pixel is calculated in the left-and-right direction of FIG. 10. Also, pixels 1003 and 1004 are determined to have a difference with the surrounding pixel that is less than the predetermined value in step S103 and are pixels (indicated by “K”) that have their determination for whether to apply the color conversion for graphic regions or the color conversion for photo regions temporarily put on hold.

As illustrated in FIG. 10, the pixels 1003 is located between the edge pixels 1001 and 1002. Thus, in step S104, the target pixel is determined to be located between edge pixels, and the processing proceeds to step S106 in which color conversion is performed on the target pixel using the color conversion method for photo regions prepared in advance. The pixels 1004 are not located between edge pixels. Thus, in step S104, the target pixel is determined to be not located between edge pixels, and the processing proceeds to step S105 in which color conversion is performed on the target pixel using the color conversion method for graphic regions prepared in advance.

In this manner, in the present embodiment, in a case where the difference with an adjacent surrounding pixel is a very small value, the color conversion method to apply is different depending on whether the target pixel is located between edge pixels. Accordingly, even in the case of a gradation region in a graphic region such as a bar graph with gradation, color conversion is performed by applying a color conversion method for photo regions on the gradation region. This allows the tone of the gradation region to be maintained.

Here, the differences between the color conversion method for graphic regions and the color conversion method for photo regions will be described. When two different input values are input into a color conversion method, two output values are output. In a case where the difference between the two output values is equal to or greater than a threshold, the two output values can be said to have retained tone. For all input values, when two combinations are input into a color conversion method, the number of differences between output values that are equal to or less than the threshold corresponds to number of non-tonality combinations. The difference between output values being equal to or less than the threshold corresponds to color degeneration occurring. When the color conversion method for graphic regions and the color conversion method for photo regions are compared, the number of non-tonality combinations in the case of performing the aforementioned using a color conversion method for graphic regions is more than the number of non-tonality combinations in the case of performing the aforementioned using a color conversion method for photo regions. This is because the color conversion method for photo regions is a color conversion method that prioritizes retaining tone, but the color conversion method for graphic regions prioritizes visual appeal and the like over the retention of tone.

In step S107, the CPU 102 determines whether or not color conversion of all of the pixels of the document data has ended. In a case where it is determined that color conversion of all of the pixels has ended, the processing proceeds to step S108. In a case where it is determined that color conversion has not ended, the next pixel is targeted, and the processing from step S102 is repeated.

In step S108, the CPU 102 executes printing processing for the document data. Specifically, for example, four items of processing including ink color separation processing, output characteristic conversion processing, quantization processing, and printing processing are executed on each pixel that has undergone color conversion in steps S105 and S106.

The ink color separation processing is processing to convert the output values of the color conversion processing, Rout, Gout, and Bout, into output values of each ink color to be printed by the inkjet printing system. In the present embodiment, it is expected that four colors, cyan, magenta, yellow, and black are used in printing. Various methods can be used to implement color conversion, and for example, a three-dimensional LUT may be used to calculate the combination of the suitable ink color pixel values (C, M, Y, K) for the combination of output pixel values (Rout, Gout, and Bout) in a similar manner as in the color conversion processing. For example, a three-dimensional LUT2 [256][256][256][4] such as that represented in the following Formulas (5) to (8) may be used.

$$C = LUT 2 [ Rout ] [ Gout ] [ Bout ] [ 0 ] \qquad ( 5 )$$

$$M = LUT 2 [ Rout ] [ Gout ] [ Bout ] [ 1 ] \qquad ( 6 )$$

$$Y = LUT 2 [ Rout ] [ Gout ] [ Bout ] [ 2 ] \qquad ( 7 )$$

$$K = LUT 2 [ Rout ] [ Gout ] [ Bout ] [ 3 ] \qquad ( 8 )$$

Also, the LUT grid number may be reduced from 256 grids to 16 grids, for example, and the table values of a plurality of grids may be interpolated to determine and output value to reduce the table size.

Next, output characteristic conversion processing is processing to convert the density of each ink color into a print dot count ratio. Specifically, the densities of each color having 256 tones are converted into dot count ratios Cout, Mout, Yout, and Kout with 1024 tones for each color. Thus, for example, a one-dimensional LUT3 [4][256] with a suitable print dot count ratio set for the density of each ink color is used as represented in the following Formulas (9) to (12).

$$Cout = LUT 3 [ 0 ] [ C ] \qquad ( 9 )$$

$$Mout = LUT 3 [ 1 ] [ M ] \qquad ( 10 )$$

$$Yout = LUT 3 [ 2 ] [ Y ] \qquad ( 11 )$$

$$Kout = LUT 3 [ 3 ] [ K ] \qquad ( 12 )$$

Also, the LUT grid number may be reduced from 256 grids to 16 grids, for example, and the table values of a plurality of grids may be interpolated to determine and output value to reduce the table size.

Next, quantization processing is processing to convert the print dot count ratios Cout, Mout, Yout, Kout of each ink color into an on/off for a print dot for each actual pixel. Various methods may be used for quantization including an error diffusion method, a dither method, and the like. For example, a dither method may be implemented as represented in the following Formulas (13) to (16).

$$Cdot = Halftone [ Cout ] [ x ] [ y ] \qquad ( 13 )$$

$$Mdot = Halftone [ Mout ] [ x ] [ y ] \qquad ( 14 )$$

$$Ydot = Halftone [ Yout ] [ x ] [ y ] \qquad ( 15 )$$

$$Kdot = Halftone [ Kout ] [ x ] [ y ] \qquad ( 16 )$$

By comparing using a threshold in accordance with each pixel position (x, y), the on/off for the print dot for each ink color is achieved. Here, the Cout, Mout, Yout, and Kout are expressed in 10 bits and have a value range from 0 to 1023. Thus, the generation probability of each print dot is Cout/1023, Mout/1023, Yout/1023, and Kout/1023.

Lastly, printing of an image onto a print medium is performed by a print head 115.

In this manner, according to the present embodiment, whether or not there is tonality is determined via the conditions of steps S102 and S104, the color conversion method for photo regions that prioritizes tonality is selected for portions that require tone reproduction, and the color conversion method for graphic regions that prioritizes visual appeal is selected for the other portions. In this manner, visual appeal and tonality can both be provided in an appropriate manner.

As illustrated in FIG. 3, only edge pixel detection may be performed on the image data beforehand. In other words, detection of an edge pixel with a difference in pixel value between the target pixel and the surrounding pixel greater than the edge level may be performed before the processing of FIG. 3. Note that in a case where white is the start point or the end point of a gradation and an edge pixel does not exist up to a white pixel, the white pixel may be set as an edge pixel.

In the present embodiment, a difference in the RGB color space is used in the tonality determination, but no such limitation is intended. The color difference ΔE in the L*a*b* color space may be used. In this case, the determination is closer to a perceptual determination. Also, in the present embodiment, in step S102, determination is performed with the pixels in the up-and-down direction and left-and-right direction of the target pixel. However, no such limitation is intended, and determination of the total difference with the target pixel may be performed using a total of eight pixels, the four pixels in the up-and-down direction and left-and-right direction and four pixels to the upper left, the upper right, the lower left, and the lower right. In this manner, a stricter determination can be performed. In a similar manner, a determination of the total difference between the target pixel and pixels two pixels away in the up-and-down direction and the left-and-right direction may be performed. In this case, a determination of a wider area can be performed.

### Second Embodiment

The differences between the second embodiment and the first embodiment will be described below. In the first embodiment described above, two color conversion methods are prepared in advance and which color conversion method to use is determined. In the present embodiment, a color conversion table (a color conversion method) is generated in an image processing apparatus and the generated color conversion table is set to be one color conversion table candidate to be applied. In this manner, a more suitable color conversion method can be applied to the input document data.

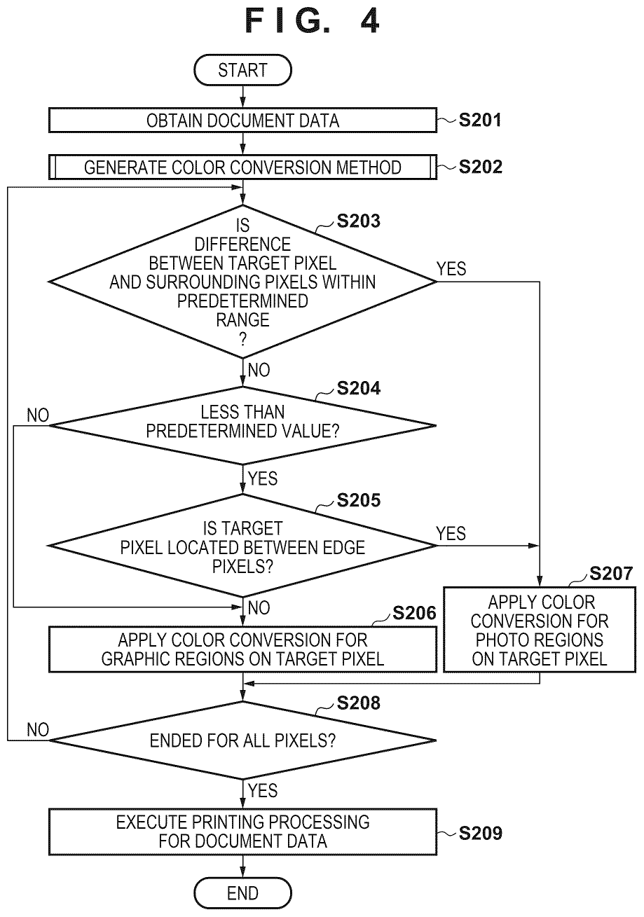

FIG. 4 is a flowchart illustrating the processing in the image processing apparatus 101 according to the present embodiment. The processing in FIG. 4 is implemented by a CPU 102 reading out a program stored on a RAM 103 and executing the program, for example. In the present embodiment, a configuration is described in which the processing of FIG. 4 is executed by the image processing apparatus 101. However, in another configuration, the processing may be executed by a printing apparatus 108 or the processing may be shared between the image processing apparatus 101 and the printing apparatus 108.

Step S201 is the same as step S101 of FIG. 3 and thus will not be described.

In step S202, the CPU 102 generates a color conversion table for correcting the color degeneration caused by separating the distance between colors in the color space.

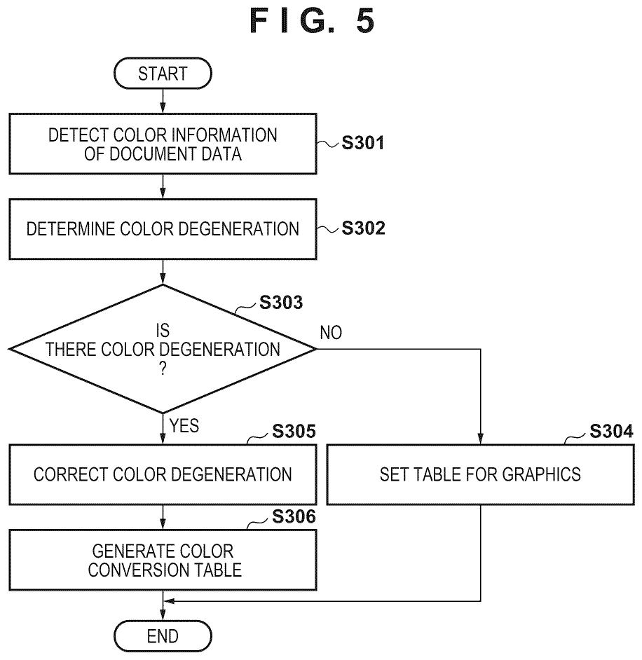

FIG. 5 is a flowchart illustrating processing executed in step S202 for generating a color conversion table for correcting color degeneration.

In step S301, the CPU 102 detects the color information of the document data obtained in step S201. The detection processing is repeated for each pixel of the document data and is executed for all of the pixels included in the document data to generate a color information list.

For example, in the case of text data with black text on a white sheet, the detected color information is black and white. Also, for example, in the case of an image such as a photo, the detected color information is a color used in the photo. The CPU 102 stores the detection result in the RAM 103 or the storage medium 104 as the color information list. Note that the color information list is initialized at the start of the step S301. The CPU 102 repeats the detection processing for each pixel of the image data and determines whether or not the color of each pixel is a color different from the color information detected up until then for all of the pixels included in the image data. In a case where it is determined that the color is difference from the color information detected up until then, the color is added and stored in the color information list.

As the determination method, whether or not the color of the target pixel is a color included in the color information list generated up until then. If it is determined to not be included, color information may be newly added to the color information list. In this manner, the color information list included in the document data can be detected. For example, in a case where the document data is sRGB data, since there are 256 tones, color information of a total of 16777216 (256×256×256) colors is detected. In this case, the color number is expanded and the processing speed is reduced. Thus, the color information may be detected discretely. For example, color information may be detected after colors are reduced from 256 tones to 16 tones. In the case of color reduction, the colors of the closest grids may be reduced. In this manner, detection of color information of a total of 4096 colors (16×16×16) is sufficient, and the processing speed can be improved.

Next, in step S302, on the basis of the color information list detected in step S301, the CPU 102 detects the number of color combinations showing color degeneration from using the pre-prepared color conversion table from among the combinations in the color information list.

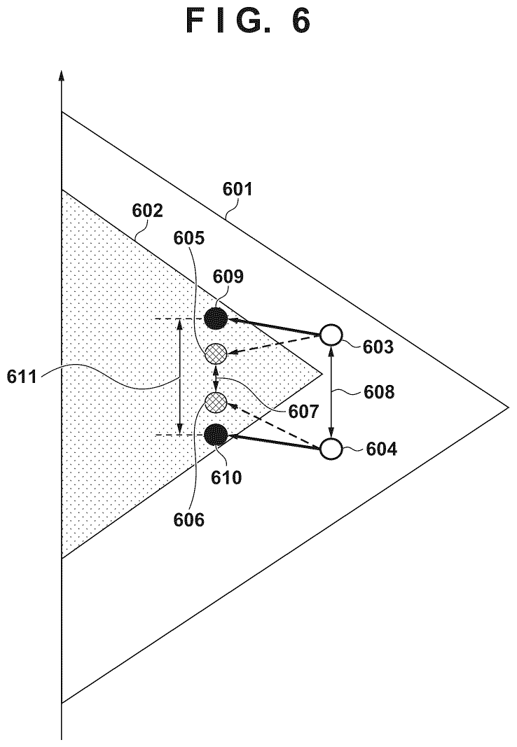

FIG. 6 is a diagram for describing color degeneration and its correction. A color reproduction region 601 is a color reproduction region of the document data and indicates an sRGB color reproduction region in the present embodiment. A color reproduction region 602 is a post-color-conversion-processing color reproduction region and corresponds to the color reproduction region of the printing apparatus 108. In FIG. 6, a color 605 is a color obtained by color conversion of a color 603 via gamut mapping. A color 606 is a color obtained by color conversion of a color 604 via gamut mapping. In a case where a color difference ΔE607 between the color 605 and the color 606 is smaller than a color difference ΔE608 between the color 603 and the color 604, it is determined that there is color degeneration. In the method for calculating the color difference ΔE, for example, the Euclidean distance in the color space is used. In the present embodiment, an example in which the Euclidean distance in a CIE-L*a*b* color space (hereinafter referred to as the color difference ΔE) is used will be described. The color difference ΔE between color (L1, a1, b1) and color (L2, a2, b2) are calculated using the following Formula (17).

$$Δ E = \sqrt{{( {L}_{1} - {L}_{2} )}^{2} + {( {a}_{1} - {a}_{2} )}^{2} + {( {b}_{1} - {b}_{2} )}^{2}} \qquad ( 17 )$$

Next, in step S303, the CPU 102 determines whether or not the number of color combinations showing color degeneration in step S302 is zero. In a case where the number of color combinations showing color degeneration is determined to be zero, color degeneration correction is determined to be not required, and the processing proceeds to step S304. In step S304, the CPU 102 sets the pre-prepared color conversion method for graphic regions (color conversion table) as the color conversion method to use in step S206. Hereinafter, the color conversion method is referred to as the color conversion table. Thereafter, the processing of FIG. 5 ends. On the other hand, in a case where the number of color combinations showing color degeneration is determined to be not zero, the processing proceeds to step S305.

In step S305, the CPU 102 performs color degeneration correction on the combination of colors showing color degeneration on the basis of the document data, the post-color-conversion document data, and the color conversion table. Color degeneration correction is processing to correct the color difference ΔE607 between the color 605 and the color 606 to a color difference ΔE611 between a color 609 and a color 610 similar to the color difference ΔE608. The color degeneration correction is repeated a number of times corresponding to the number of color combinations showing color degeneration. The result of the color degeneration correction is stored in a table as pre-correction color information and post-correction color information. For example, in FIG. 6, the color information is color information in a CIE-L*a*b* color space. Thus, the information may be converted into the color space of the image data at the time of input and the image data at the time of output. In this case, the pre-color-degeneration-correction color information in the color space of the image at the time of input and the post-color-degeneration-correction color information in the color space of the image data at the time of output are stored in a table. In FIG. 6, the post-color-degeneration-correction color 609 and the color 610 are located on an extension line from the color 605 to the color 606, but in the present embodiment, no such limitation is intended. As long as the color difference ΔE611 between the color 609 and the color 610 is separated only by a distance corresponding to the color difference ΔE608, the direction in the CIE-L*a*b* color space may be any direction including the brightness direction, the chroma direction, or the hue angle direction. Also, instead of one direction, any combination of the brightness direction, the chroma direction, and the hue angle direction may be used. Also, FIG. 6 illustrates an example in which both the color 603 and the color 604 are corrected. However, correction may be performed by correcting only one color to separate them a distance corresponding to the color difference ΔE608.

In step S306, the CPU 102 generates a color conversion table using the color degeneration correction result of step S305. The pre-prepared color conversion table is a table for converting the color 603 to the color 605 and the color 604 to the color 606. As a result of the color degeneration correction of step S305, the color conversion table is changed to convert the color 603 to the color 609 and the color 604 to the color 610. The color conversion table is repeatedly changed a number of times corresponding to the number of color combinations showing color degeneration. As described above, in step S202, a post-color-degeneration-correction color conversion table is generated. After step S306, the processing of FIG. 5 ends.

Steps S203 to S205 and S207 are the same as steps S102 to S104 and S106 of FIG. 3 and thus will not be described.

In step S206, the CPU 102 determines that the target pixel is a target for graphic region color conversion and performs color conversion on the target pixel via a color conversion table for graphic regions. At this time, if step S304 of FIG. 5 is being executed, in step S206, the pre-prepared color conversion table for graphic regions is used. On the other hand, if step S306 of FIG. 5 is being executed, in step S206, the post-color-degeneration-correction color conversion table generated in step S306 is used.

Steps S208 and S209 are the same as steps S107 and S108 and thus will not be described.

As described above, according to the present embodiment, a color conversion method is generated in an image processing apparatus and one color conversion method candidate to which the generated color conversion method may be applied is set. In this manner, a more suitable color conversion method can be applied to the input document data.

### Modified Example

In a case where the region for setting the color conversion method and the region where the set color conversion method is applied are the same, the color conversion method may be set taking into account unnecessary colors. As a result, an appropriate color conversion result may not be obtained. In step S301, color information is extracted for all of the pixels in the document data. However, greater numbers of colors makes reducing the color degeneration by all of the color combinations more difficult. Also, color degeneration is hard to recognize in isolated points of one pixel and thin lines of one pixel, and there is not a great need to reduce color degeneration there. Also, if the color of isolated points and thin lines are taken into account, the color degeneration correction result for other color information will be reduced.

Regarding this, in the present modified example, instead of setting the color conversion method using the color information of all of the pixels in the document data, a first region to use for setting the color conversion method and a second region to not use for setting the color conversion method are set, and the color conversion method is set using the color information of the first region. In the present modified example, a region required for color discrimination from the document data is set, and a color conversion table is generated limited to the color information of this region.

In the present modified example, the processing of FIG. 4 is executed, and the color conversion table of step S202 is generated. However, in step S301 of FIG. 5, color information is detected as described below.

In the present modified example, color information identifiable by a person and discernible in the output of the printing apparatus 108 is defined as color information for a region with an area equal to or greater than a predetermined area in a plane, and this region is set as the first region. Specifically, for example, in the document data, a region with pixels that continuously have the same color information for two pixels or more in the vertical direction and two pixels or more in the horizontal direction is set as the first region.

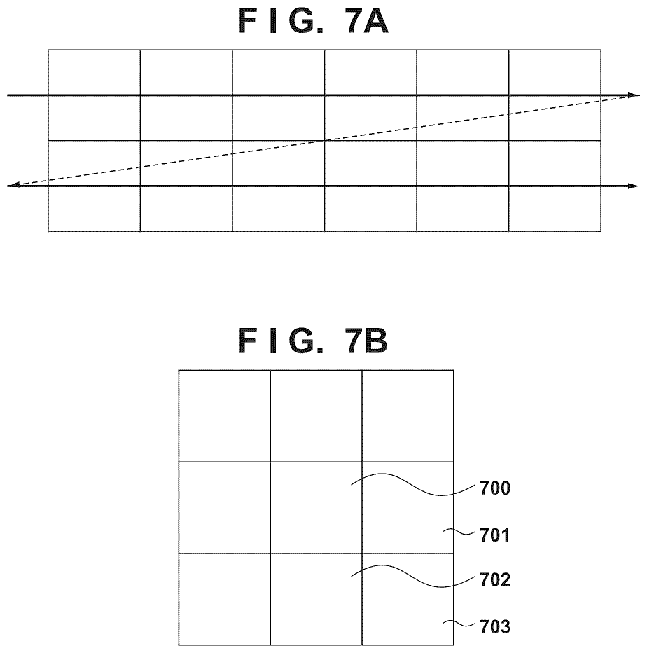

FIGS. 7A and 7B are diagrams for describing the first region setting processing according to the present modified example. As indicated by the arrow in FIG. 7A, line processing is executed on the document data sequentially on a pixel basis. In processing on a pixel basis, the CPU 102 determines whether or not the color information of each of the three pixels (pixel 701, pixel 702, and pixel 703) surrounding a processing target pixel (target pixel) 700 illustrated in FIG. 7B is the same as the color information of the target pixel. In a case where it is determined to be the same, the four pixels including the target pixel are set as the first region. Note that pixels already set as the first region may be re-set as the first region via the processing on a pixel basis. Also, the method for setting the first region is not limited to that described above, and it is sufficient that a region of the same color information with a predetermined area or greater on a plane can be extracted. Also, in the present modified example, a region with the same color information is extracted. However, in other examples, despite being the same color information in the original image data, for example, in irreversibly compressed image data such as JPEG, the same color information may vary within a predetermined range. Thus, a region with the same color information, for example, with the color difference ΔE within 1.0 or a difference in RGB vale within a predetermined value may be extracted as a region with the same color information. Alternatively, a permittable range of variation may be settable.

Step S302 onward is executed in a similar manner to as described in the second embodiment. In the case of the processing described in the present modified example, the region where the generated color conversion method is actually applied is determined in steps S203 to S205. At this time, isolated pixels, thin lines, and the like that are not extracted as regions with the same color information with a predetermined area or greater are taken as target regions for applying the color conversion method. Thus, isolated pixels, thin lines, and the like configured of a color close to that of the color that is the target of color degeneration correction can be corrected to a suitable color in a similar manner.

According to the present modified example, in the document data, a first region used for setting the color conversion method and a second region not used for setting the color conversion method are set. With this configuration, an appropriate color conversion method can be set on the basis of only the information of a region (that is, the first region) that requires color degeneration correction. As a result, a color conversion result suitable for the printing apparatus 108 can be obtained without executing unnecessary color degeneration correction.

### Third Embodiment

The differences between the third embodiment and the first embodiment and the second embodiment will be described below. In the present embodiment, processing for more accurately detecting a gradation region will be described.

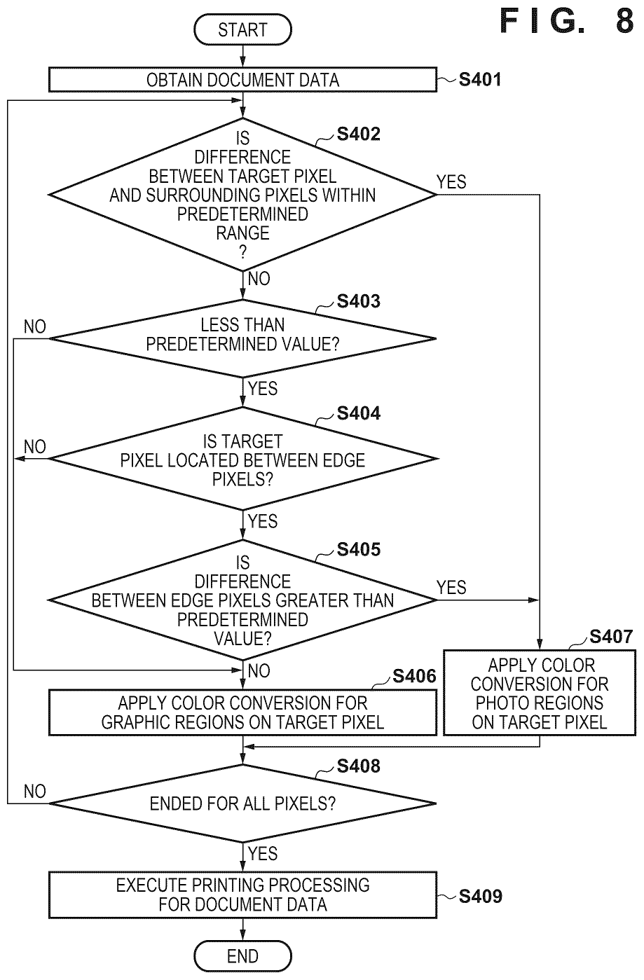

FIG. 8 is a flowchart illustrating the processing in the image processing apparatus 101 according to the present embodiment. The processing in FIG. 8 is implemented by a CPU 102 reading out a program stored on a RAM 103 and executing the program, for example. In the present embodiment, a configuration is described in which the processing of FIG. 8 is executed by the image processing apparatus 101. However, in another configuration, the processing may be executed by a printing apparatus 108 or the processing may be shared between the image processing apparatus 101 and the printing apparatus 108.

Steps S401 to S404 are the same as steps S101 to S104 of FIG. 3 and thus will not be described. In a case where the target pixel is determined to be located between edge pixels in step S404, the processing proceeds to step S405.

In the present embodiment, in step S405, processing is also executed on the target pixel determined to be located between edge pixels to determine whether or not the target pixel is a pixel of a gradation region.

To simplify description, processing for determining whether a pixel is a pixel of a gradation region in the horizontal direction will be described. The coordinates of the two edge pixels in the horizontal direction are (x1, y1) and (x2, y1). The adjacent differences of the pixels between the two edge pixels are all less than the noise level. An inter-edge difference ΔEDGE in this case is calculated via Formulas (18) to (21).

$$Δ Re = ABS ( R ( x 1 , y 1 ) - R ( x 2 , y 1 ) ) \qquad ( 18 )$$

$$Δ Ge = ABS ( G ( x 1 , y 1 ) - G ( x 2 , y 1 ) ) \qquad ( 19 )$$

$$Δ Be = ABS ( B ( x 1 , y 1 ) - B ( x 2 , y 1 ) ) \qquad ( 20 )$$

$$Δ EDGE = MAX ( Δ Re , Δ Ge , Δ Be ) \qquad ( 21 )$$

In step S405, the CPU 102 determines whether or not the ΔEDGE is greater than a predetermined value. It is plausible that in a gradation region, in any direction in the horizontal direction, the difference in pixel value with the surrounding pixel is accumulated, and thus the difference in pixel values between the edge pixels becomes greater than a predetermined value. Accordingly, in a case where ΔEDGE is determined to be greater than the predetermined value, the target pixel is determined to be a gradation region pixel. The predetermined value may be the edge level, for example. It may also be any value wished to be detected as a gradation region and may be the difference in pixel values between the start point and the end point of a gradation, for example.

Processing for determining whether a pixel is a pixel of a gradation region in the vertical direction will be described. The coordinates of the two edge pixels in the vertical direction are (x3, y3) and (x3, y4). The adjacent differences of the pixels between the two edge pixels are all less than the noise level. An inter-edge difference ΔEDGE in this case is calculated via Formulas (22) to (25).

$$Δ Re = ABS ( R ( x 3 , y 3 ) - R ( x3 , y 4 ) ) \qquad ( 22 )$$

$$Δ Ge = ABS ( G ( x 3 , y 3 ) - G ( x 3 , y 4 ) ) \qquad ( 23 )$$

$$Δ Be = ABS ( B ( x 3 , y 3 ) - B ( x 3 , y 4 ) ) \qquad ( 24 )$$

$$Δ EDGE = MAX ( Δ Re , Δ Ge , Δ Be ) \qquad ( 25 )$$

In step S405, the CPU 102 determines whether or not the ΔEDGE is greater than a predetermined value. It is plausible that in a gradation region, in any direction in the vertical direction, the difference in pixel value with the surrounding pixel is accumulated, and thus the difference in pixel values between the edge pixels becomes greater than a predetermined value. Accordingly, in a case where ΔEDGE is determined to be greater than the predetermined value, the target pixel is determined to be a gradation region pixel. The predetermined value may be the edge level, for example. It may also be any value wished to be detected as a gradation region and may be the difference in pixel values between the start point and the end point of a gradation, for example.

In step S405, in a case where it is determined that the ΔEDGE is greater than the predetermined value, the processing proceeds to step S407. In step S407, the CPU 102 determines that the target pixel is a target for photo region color conversion and performs color conversion on the target pixel via a color conversion method for photo regions prepared in advance. This allows the gradation region to be detected with higher accuracy. Step S408 follows step S407. On the other hand, in step S405, in a case where it is determined that the ΔEDGE is not greater than the predetermined value, the processing proceeds to step S406. In step S406, the CPU 102 determines that the target pixel is a target for graphic region color conversion and performs color conversion on the target pixel via a color conversion method for graphic regions prepared in advance. Step S408 follows step S406.

The processing of step S405 is executed for each pixel. However, since the determination is performed for the difference between edge pixels, the determination result is the same for all of the pixels between the edge pixels. In other words, if it is determined that the value for any of the pixels between edge pixels is greater than the predetermined value, then the value for all of the pixels between the edge pixels will be determined to be greater than the predetermined value and the processing will proceed to step S407.

Steps S408 to S409 are the same as steps S107 to S108 of FIG. 3 and thus will not be described.

As described above, according to the present embodiment, a gradation region can be detected with higher accuracy. For all of the pixels in a region determined to be a gradation region and that is located in a region between edge pixels, a color conversion method that prioritizes tonality is applied. Accordingly, not only for a photo region, but for a portion for which tonality is important such as a gradation region in a graphic region, a color conversion method that prioritizes tonality is applied. This can help suppress unnatural tone gradients and color transitions caused by a disruption of the tonality, allowing a good output image to be obtained.

Note that in the present embodiment, a difference in the RGB color space is used in the ΔEDGE determination, but no such limitation is intended. The color difference ΔE in the L*a*b* color space may be used. In this case, the determination is closer to a perceptual determination.

### Fourth Embodiment

The differences between the fourth embodiment and the first embodiment and the third embodiment will be described below. In the third embodiment, a gradation region is detected using the characteristic that the difference in the pixel values between edge pixels continuously accumulates. In the present embodiment described here, processing to detect a gradation region uses another distinctive characteristic relating to a gradation region.

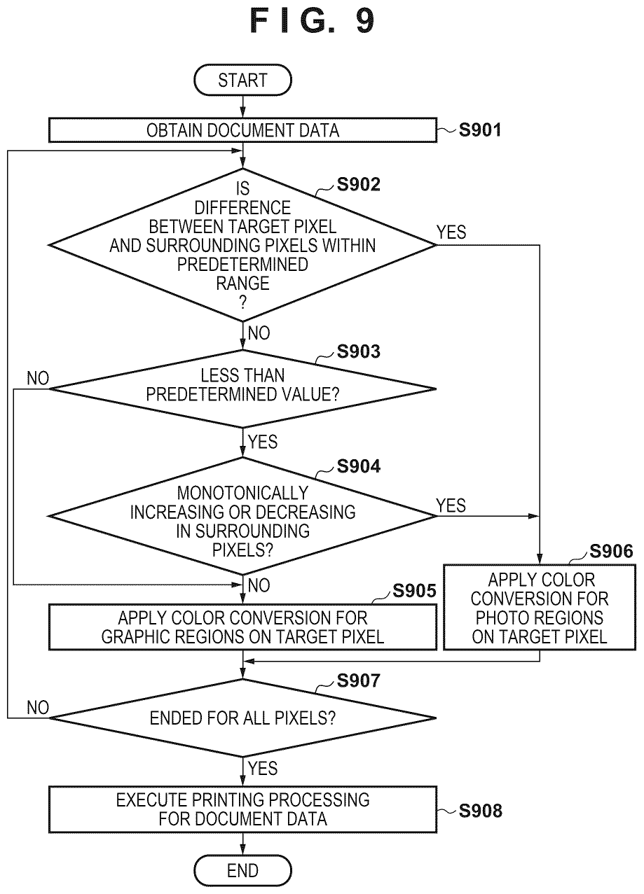

FIG. 9 is a flowchart illustrating the processing in the image processing apparatus 101 according to the present embodiment. The processing in FIG. 9 is implemented by a CPU 102 reading out a program stored on a RAM 103 and executing the program, for example. In the present embodiment, a configuration is described in which the processing of FIG. 9 is executed by the image processing apparatus 101. However, in another configuration, the processing may be executed by a printing apparatus 108 or the processing may be shared between the image processing apparatus 101 and the printing apparatus 108.

Steps S901 to S903 are the same as steps S101 to S103 of FIG. 3 and thus will not be described. In a case where it is determined in step S903 that the difference in pixel value is less than the predetermined value, the processing proceeds to step S904.

In the present embodiment, in step S904, processing is also executed on the target pixel determined to be between edge pixels to determine whether or not the target pixel is a pixel of a gradation region. Between consecutive pixels in a gradation region, there is a characteristic that the density continuously changes. In other words, between consecutive pixels in a gradation region, the density values monotonically increase or decrease. Regarding this, in the present embodiment, whether or not the pixel values of three pixels consecutively located monotonically increase or decrease is determined to detect a gradation region.

Here, the three consecutive colors in the vertical direction or the horizontal direction are defined as a color C1=(R1, G1, B1), a color C2=(R2, G2, B2), and a color C3 (R3, G3, B3).

In step S904, the CPU 102 determines whether or not the condition of the pixel values monotonically increasing or decreasing in an array including the target pixel and surrounding pixels is satisfied. Specifically, for example, the CPU 102 determines whether or not the condition of all of the colors, the color C1, the color C2, and the color C3, being different and condition of the following Formulas (26) to (31) are simultaneously satisfied.

$$MIN ( R 3 , MIN ( R 2 , R 1 ) ) \neq R 2 \qquad ( 26 )$$

$$MAX ( MAX ( R 2 , R 1 ) , R 3 ) \neq R 2 \qquad ( 27 )$$

$$MIN ( G 3 , MIN ( G 2 , G 1 ) ) \neq G 2 \qquad ( 28 )$$

$$MAX ( MAX ( G 2 , G 1 ) , G 3 ) \neq G 2 \qquad ( 29 )$$

$$MIN ( B 3 , MIN ( B 2 , B 1 ) ) \neq B 2 \qquad ( 30 )$$

$$MAX ( MAX ( B 2 , B 1 ) , B 3 ) \neq B 2 \qquad ( 31 )$$

Here, MIN(a, b) is a function for outputting a when a<b, and MAX(a, b) is a function for outputting a when a>b.

In a case where the RGB value monotonically increases or decreases across three consecutive pixels in the vertical direction or the horizontal direction (in other words, the condition is satisfied), also including a case in which the pixel values are equal, Formulas (25) to (30) are simultaneously satisfied. In other words, among the three consecutive pixels in the vertical direction or the horizontal direction, the pixel value in the middle is not the maximum and not the minimum. In a case where the functions described above are satisfied across the plurality of consecutive pixels in the horizontal direction or the vertical direction, the region of the plurality of pixels can be determined to be a gradation region. In this case, in step S904, the conditions are determined to be satisfied, and the processing proceeds to step S906. In step S906, the CPU 102 determines that the target pixel is a target for photo region color conversion and performs color conversion on the target pixel via a color conversion method for photo regions prepared in advance. This allows the gradation region to be detected with higher accuracy. Step S907 follows step S906. In a case where, in step S904, it is determined that the conditions are not satisfied, the processing proceeds to step S905. In step S905, the CPU 102 determines that the target pixel is a target for graphic region color conversion and performs color conversion on the target pixel via a color conversion method for graphic regions prepared in advance. Step S907 follows step S905.

Steps S907 to S908 are the same as steps S107 to S108 of FIG. 3 and thus will not be described.

As described above, according to the present embodiment, in a case where the value of three consecutive colors monotonically increases or decreases, a gradation region is determined. Thus, regardless of the gradient (density increase rate) of the gradation, the gradation region can be correctly detected. In particular, in a gradation region that changes greatly in terms of hue, the adjacent difference may be great. However, even in such cases, the gradation region can be correctly detected. Also, a threshold is unnecessary, and thus threshold adjustment can be made unnecessary.

Note that in the present embodiment, a difference in the RGB color space is used in the ΔEDGE determination, but no such limitation is intended. The color difference ΔE in the L*a*b* color space may be used. In this case, the determination is closer to a perceptual determination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-096897, filed Jun. 14, 2024, which is hereby incorporated by reference herein in its entirety.

What is claimed is:

1. An image processing apparatus comprising:
at least one memory and at least one processor which function as:
an input unit configured to input image data, and
a color conversion unit configured to, on the image data input by the input unit, execute color conversion using a first color conversion method on a target pixel with a difference in pixel value between the target pixel and a surrounding pixel in a case where the target pixel satisfies a condition and execute color conversion using a second color conversion method different from the first color conversion method on the target pixel in a case where the target pixel does not satisfy the condition,
wherein a result of executing color conversion using the first color conversion method maintains tonality more than a result of color conversion using the second color conversion method.

2. The image processing apparatus according to claim 1, wherein
the at least one memory and the at least one processor further function as:
a correction unit configured to correct the second color conversion method on a basis of the image data input by the input unit.

3. The image processing apparatus according to claim 2, wherein
the correction unit
obtains a third color and a fourth color by inputting a first color and a second color represented by the image data into the second color conversion method, and
in a case where a result of comparing a distance between the first color and the second color and a distance between the third color and the fourth color shows color degeneration, corrects the second color conversion method to remove color degeneration, and
the color conversion unit executes color conversion on the target pixel using the second color conversion method corrected by the correction unit instead of the second color conversion method in a case where the target pixel does not satisfy the condition.

4. The image processing apparatus according to claim 3, wherein
the correction unit corrects the second color conversion method to separate the distance between the third color and the fourth color.

5. The image processing apparatus according to claim 4, wherein
the correction unit corrects the second color conversion method so that the distance between the third color and the fourth color separates in at least one direction of a brightness direction, a chroma direction, and a hue angle direction.

6. The image processing apparatus according to claim 3, wherein
correction by the correction unit is not performed in a case where the color degeneration is not showing, and
the color conversion unit executes color conversion on the target pixel using the second color conversion method in a case where the target pixel does not satisfy the condition.

7. The image processing apparatus according to claim 3, wherein
the at least one memory and the at least one processor further function as:
a setting unit configured to set a region in an image represented by the image data,
wherein the first color and the second color are colors obtained from a region set by the setting unit.

8. The image processing apparatus according to claim 7, wherein
the region is a region with a predetermined area.

9. The image processing apparatus according to claim 7, wherein
the region is a region including color information of a predetermined range.

10. The image processing apparatus according to claim 7, wherein
a region set by the setting unit is different from a region applied with the second color conversion method or the second color conversion method corrected by the correction unit.

11. The image processing apparatus according to claim 1, wherein
the condition includes the target pixel being located between edge pixels of a predetermined region.

12. The image processing apparatus according to claim 11, wherein
a difference in pixel values between the edge pixels is greater than a predetermined value.

13. The image processing apparatus according to claim 11, wherein
in the predetermined region, pixel values increase or decreases in an array of pixels including the target pixel and a pixel adjacent to the target pixel.

14. The image processing apparatus according to claim 11, wherein
the predetermined region is a gradation region.

15. The image processing apparatus according to claim 1, wherein
the at least one memory and the at least one processor further function as:
a print control unit configured to executed processing for printing an image on a print medium on a basis of image data on which color conversion has been executed by the color conversion unit.

16. The image processing apparatus according to claim 15, wherein
the processing for printing the image includes ink color separation processing, output characteristic conversion processing, quantization processing, and printing processing.

17. The image processing apparatus according to claim 1, wherein
the first color conversion method and the second color conversion method are methods of mapping an input color gamut on an output color gamut of a printing apparatus.

18. A method executed by an image processing apparatus comprising:
inputting image data; and
on the image data input by the input unit, executing color conversion using a first color conversion method on a target pixel with a difference in pixel value between the target pixel and a surrounding pixel in a case where the target pixel satisfies a condition and executing color conversion using a second color conversion method different from the first color conversion method on the target pixel in a case where the target pixel does not satisfy the condition,
wherein a result of executing color conversion using the first color conversion method maintains tonality more than a result of color conversion using the second color conversion method.

19. A non-transitory computer-readable storage medium that stores one or more programs including instructions, which when executed by at least one memory and at least one processor of an image processing apparatus, cause the image processing apparatus to:
input image data; and
on the image data input by the input unit, execute color conversion using a first color conversion method on a target pixel with a difference in pixel value between the target pixel and a surrounding pixel in a case where the target pixel satisfies a condition and execute color conversion using a second color conversion method different from the first color conversion method on the target pixel in a case where the target pixel does not satisfy the condition,
wherein a result of executing color conversion using the first color conversion method maintains tonality more than a result of color conversion using the second color conversion method.
